(19) United States
(12) Patent Application Publication
(10) Pub. No.: US 2014/0165582 A1
(43) Pub. Date: Jun. 19, 2014

(54) CROSS-FLOW TURBINE ENGINE

(71) Applicant: UNITED TECHNOLOGIES CORPORATION, Hartford, CT (US)

(72) Inventors: Victor Pascu, San Diego, CA (US); Nipulkumar G. Shah, San Diego, CA (US)

(73) Assignee: UNITED TECHNOLOGIES CORPORATION, Hartford, CT (US)

(21) Appl. No.: 13/716,247

(22) Filed: Dec. 17, 2012

(51) Int. Cl. F02C 7/18; F02C 9/16

(52) U.S. Cl. CPC F02C 7/18; F02C 9/16
USPC 60/773; 60/805; 60/806

(57) ABSTRACT

An embodiment of the present invention is a gas turbine engine including a compressor, a turbine, an annular combustor, an exhaust duct, a first engine shaft bearing, and a second engine shaft bearing. The turbine has an axial flow direction toward the compressor. The combustor has an axial flow direction away from the compressor. The exhaust duct is disposed between the compressor and the combustor. The first engine shaft bearing is disposed on an axial side of the compressor opposite the turbine. The second engine shaft bearing is disposed on an axial side of the turbine opposite the compressor.

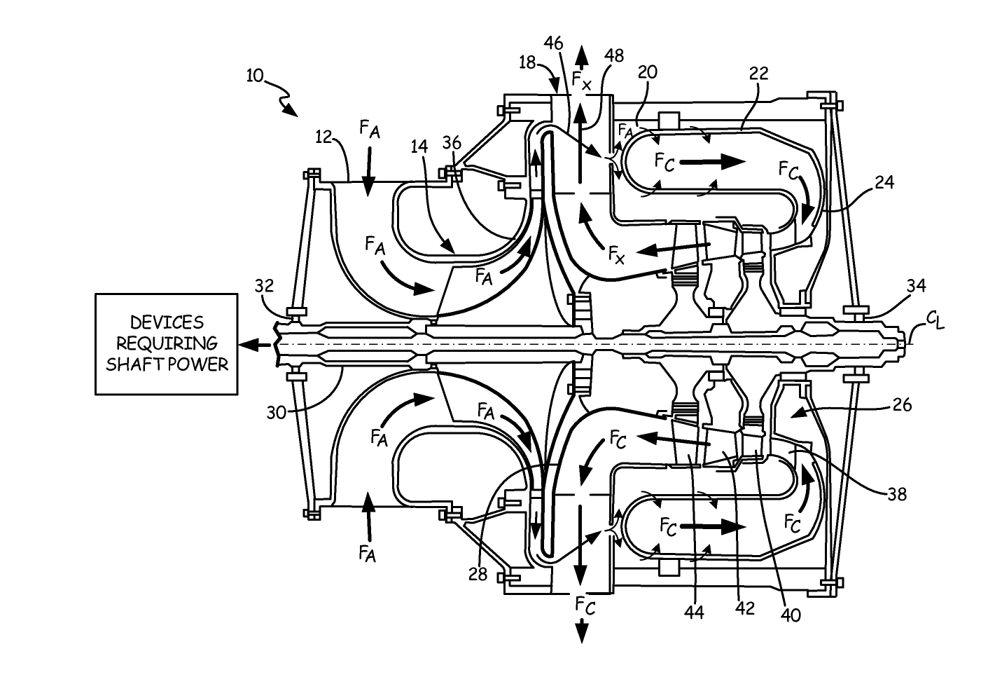

### BACKGROUND

The present invention relates gas turbine engines bearings. In particular, the invention relates to reducing cooling required for engine bearings for a gas turbine engine.

A turbine engine ignites compressed air and fuel in a combustion chamber, or combustor, to create a flow of hot combustion gases to drive one or more stages of turbines. The turbine extracts energy from the flow of hot combustion gases to drive an engine shaft. The engine shaft drives a compressor to provide a flow of compressed air. The engine shaft may also supply shaft power for use by a fan to provide thrust in a turbofan engine or for use by, for example, an electrical generator.

Engine bearings support the engine shaft at various points. At least some of the engine bearings are located in hot environments within the engine. These engine bearings are lubricated with oil by means of an oil system. Due to the hot environment, oil flow beyond what would normally be necessary is required for the oil to adequately cool the bearings and prevent premature failure. This additional oil flow for bearing cooling leads to increased capacity requirements for an engine oil pump, oil cooling heat exchanger, and tubes carrying oil to and from the bearings. Reducing the capacity requirements for the engine oil system may lead to a reduction in engine weight, lower costs, and increased engine reliability.

### SUMMARY

An embodiment of the present invention is a gas turbine engine including a compressor, a turbine, an annular combustor, an exhaust duct, a first engine shaft bearing, and a second engine shaft bearing. The turbine has an axial flow direction toward the compressor. The combustor has an axial flow direction away from the compressor. The exhaust duct is disposed between the compressor and the combustor. The first engine shaft bearing is disposed on an axial side of the compressor opposite the turbine. The second engine shaft bearing is disposed on an axial side of the turbine opposite the compressor.

### BRIEF DESCRIPTION OF THE DRAWINGS

The figure depicts a side cross-sectional view of a gas turbine engine in an embodiment.

### DETAILED DESCRIPTION

In some gas turbine engines, a general axial flow through a compressor and a general axial flow through a turbine are in the same axial direction, such that an engine bearing may need to be located between the compressor and the turbine, which is a hot environment. Further, in such a design, an engine bearing may need to be located near a turbine exhaust, which may be an even hotter environment. Extensive cooling is used for engine bearings in such locations.

Gas turbine engines embodying the present invention reduce cooling requirements for engine bearings by creating a cool zone for an engine bearing at an end of the shaft near the turbine. By employing an annular combustor having an axial flow direction opposite that of a turbine and orienting the turbine so that its axial flow direction is toward a compressor, hot gases from the turbine exhaust radially between the compressor and the combustor, and away from the engine bearing. This eliminates the need to place the engine bearing in a hot region within the engine, greatly reducing energy expended for cooling. In addition, because the engine bearing is at an outer end of the gas turbine engine, the engine design is simpler; and maintenance and inspection of the engine bearing is more convenient. Also, because of this configuration, turbine housing struts need not be located a gas path. In some engines, these struts not only provide structural support, but create a passage for oil tubes to and from a rear oil bearing. Locating these struts in a high velocity engine gas path induces high pressure losses, which not only reduce engine performance, but create noise in an engine exhaust. Finally, hot gases from the turbine are exhausted radially between the compressor and the combustor, a heat exchanger may be readily employed to recuperate some of waste heat in the hot gases and further improve the efficiency of the gas turbine engine.

The figure is a side cross-sectional view of a gas turbine engine embodying the present invention. The view in the figure is a longitudinal sectional view along an engine axis, center line C_{L}. The figure shows gas turbine engine 10 including air inlet structure 12, compressor 14, cross-flow device 18, combustor plenum 20, combustor 22, transition duct 24, turbine 26, exhaust duct 28, shaft 30, first engine shaft bearing 32, and second engine shaft bearing 34.

In an embodiment, compressor 14 is a single-stage centrifugal flow compressor including compressor rotor 36. Combustor 22 is an annular reverse flow combustor. Turbine 26 is a two-stage, axial flow turbine including first stage nozzle 38, first stage rotor 40, second stage nozzle 42, and second stage rotor 44. Cross-flow device 18 includes two flow paths, compressed air flow path 46 and exhaust gas flow path 48. Compressed air flow path 46 and exhaust gas flow path 48 are not in fluid contact with each other. In an embodiment, cross-flow device 18 is an air-to-air heat exchanger and compressed air flow path 46 and exhaust gas flow path 48 are a series of passages arranged such that compressed air flow path 46 and exhaust gas flow path 48 are in thermal contact with each other. Gas turbine engine 10 may be, for example, an auxiliary power unit. In an embodiment, gas turbine engine 10 is an auxiliary power unit for use aboard an aircraft.

Compressor 14 is positioned between air inlet structure 12 and cross-flow device 18 such that compressor 14 is in fluid communication with air inlet structure 12 and cross-flow device 18. Cross-flow device 18 is positioned between compressor 14 and combustor plenum 20 such that compressor 14 is in fluid communication with combustor plenum 20 by way of compressed air flow path 46. In an embodiment, combustor plenum 20 is an annular structure circumferentially surrounding combustor 22. An interior of combustor 22 is in fluid communication with combustor plenum 20 by way of a plurality of openings in combustor 22. In various embodiments, the plurality of openings may be combustion air holes, dilution holes, impingement cooling holes, and effusion cooling holes as are known in the art. Thus, compressed air flow path 46 is part of a flow path between compressor 14 and combustor 22 and serves to fluidly connect compressor 14 to combustor 22.

As noted above, combustor 22 is an annular reverse flow combustor, that is, a general axial direction of flow through combustor 22 is opposite of a general direction of axial flow through turbine 26. Combustor 22 annularly surrounds turbine 26. Transition duct 24 connects combustor 22 to turbine 26. Turbine 26 is oriented such that the general direction of flow through turbine 26 is toward compressor 14. Exhaust duct 28 is disposed between compressor 14 and combustor 22. Exhaust 28 connects turbine 26 to exhaust gas flow path 48 of cross-flow device 18. Exhaust gas flow path 48 leads to an outside of turbine engine 10, for example, to a volute or other structure (not shown) which directs exhaust gases to the outside of gas turbine engine 10.

First stage rotor 40 and second stage rotor 44 are connected to each other and to shaft 30, such that they rotate together. First stage nozzle 38 is a static component on a side of first stage rotor 40 opposite second stage rotor 44. Second stage nozzle 42 is a static component between first stage rotor 40 and second stage rotor 44. On the side of compressor 14 opposite turbine 26, shaft 30 is connected to devices requiring shaft power (not shown). Such devices may be, for example, an electrical generator for supplying aircraft electrical power, or another compressor for supplying compressed air for engine starting or for an environmental control system. Shaft 30 runs along center line C_{L} and is supported within gas turbine engine 10 by first engine shaft bearing 32, and second engine shaft bearing 34. First engine shaft bearing 32 is disposed on an axial side of compressor 14 opposite turbine 26. Second engine shaft bearing 34 is disposed on an axial side of turbine 26 opposite compressor 14.

In operation, flow of air F_{A} enters air inlet structure 12 and flows to compressor 14 where it is accelerated and compressed by the centrifugal action of rotating compressor rotor 36. The flow of air F_{A} enters cross-flow device 18, flows through compressed air flow path 46, and into combustor plenum 20. Flow of air F_{A} then enters into combustor 18 where it mixes with fuel and is ignited, producing a flow of high temperature, high pressure combustion gases F_{C}.

High temperature, high pressure combustion gases F_{C} flow radially inward from combustor 22 through transition duct 24, to turbine 26. In doing so, transition duct 24 reverses a general axial flow direction of combustion gases F_{C}. At turbine 26, combustion gases F_{C} enter at first stage nozzle 38 which aligns the flow of combustion gases F_{C} for an efficient attack angle on first stage rotor 40. Combustion gases F_{C} expand rapidly as they flow past first stage rotor 40, propelling the rotation of first stage rotor 40. Combustion gases F_{C} then flow through second stage nozzle 42, which again aligns combustion gases F_{C} for an efficient attack angle on second stage rotor 44. Combustion gases F_{C} again expand rapidly as they flow past second stage rotor 44, propelling the rotation of second stage rotor 44. First stage rotor 40 and second stage turbine 42 rotate connected shaft 30 to provide shaft power. Exhaust gases F_{X} flowing out of turbine 26 have a much lower temperature than combustion gases F_{C} entering turbine 26. Exhaust gases F_{X} flow out of turbine 26 flow into exhaust duct 28 which changes the flow direction of exhaust gases F_{X} from axial toward compressor 14 to radially outward between compressor 14 and combustor 22. Exhaust gases F_{X} then flow through exhaust gas flow path 48 of cross-flow device 18. Finally, exhaust gases F_{X} are exhausted from cross-flow device 18 to the outside of gas turbine engine 10.

The arrangement of compressor 14, combustor 22, and turbine 26 as described above and shown in the figure places second engine bearing 34 in a cool zone at an outer end of gas turbine engine 10. First engine bearing 32 also in a cool zone at an outer end of gas turbine engine 10. As a result of the arrangement, bearing cooling may be greatly reduced. In addition, by locating first engine bearing 32 and second engine bearing 34 at outer ends of gas turbine engine 10, maintenance and inspection of engine bearings is more convenient and less costly.

In an embodiment where cross-flow device 18 is an air-to-air heat exchanger, heat is recuperated from hot exhaust gases F_{X} and conducted into flow of air F_{A} as the two flows pass through cross-flow device 18. Although flow of air F_{A} in compressed air flow path 46 and combustion gases F_{C} in exhaust gas flow path 48 do not mix within cross-flow device 18, heat is transferred because compressed air flow path 46 and exhaust gas flow path 48 are in thermal contact. This recuperation of waste heat from exhaust gases F_{X} improves the operating efficiency of gas turbine engine 10.

In the embodiment shown in the figure, compressor 14 is a single-stage centrifugal flow compressor and turbine 26 is a two-stage, axial flow turbine. However, it is understood that the present invention includes embodiments where compressor 14 is, for example, a multi-stage axial flow compressor or a compressor including both axial and centrifugal flow stages; or where turbine 26 is a single-stage turbine.

Embodiments of the present invention reduce or eliminate cooling requirements for engine bearings in gas turbine engines by creating a cool zone for an engine bearing at an end of the shaft near a turbine. A turbine having an axial flow direction toward a compressor, and an annular combustor having an axial flow direction opposite that of the turbine, are arranged to allow hot gases from the turbine to exhaust radially between the compressor and the combustor, and away from an engine bearing at the end of the shaft near the turbine. This eliminates the need to place the engine bearing in a hot region within the engine, reducing energy expended for cooling. In addition, because the engine bearing is at an outer end of the gas turbine engine, maintenance and inspection of the engine bearing is more convenient. Also, with this configuration, turbine housing struts need not be located a gas path, thus improving engine performance and reducing exhaust noise. Finally, because hot gases from the turbine are exhausted radially between the compressor and the combustor, a heat exchanger may be readily employed to recuperate some of waste heat in the hot gases and further improve the efficiency of the gas turbine engine.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

Discussion of Possible Embodiments

1. A gas turbine engine comprising:
a compressor;
a turbine connected to the compressor by an engine shaft, the turbine having an axial flow direction toward the compressor;
an annular combustor having an axial flow direction away from the compressor;
an exhaust duct disposed between the compressor and the combustor;
a first engine shaft bearing supporting the engine shaft on an axial side of the compressor opposite the turbine; and
a second engine shaft bearing supporting the engine shaft on an axial side of the turbine opposite the compressor.

2. The engine of claim 1, further including cross-flow device, the cross-flow device including a compressed air flow path, and an exhaust gas flow path not in fluid contact with the compressed air flow path; wherein the exhaust duct is fluidly connected to the exhaust gas flow path and the compressed air flow path fluidly connects the compressor to the combustor.

3. The engine of claim 2, wherein the cross-flow device is an air-to-air heat exchanger and the compressed air flow path and the exhaust gas flow path are in thermal contact.

4. The engine of claim 1, wherein the turbine is an axial flow turbine.

5. The engine of claim 4, wherein the compressor is centrifugal flow compressor.

6. The engine of claim 4, wherein the compressor is an axial flow compressor.

7. The engine of claim 4, wherein the compressor includes both axial and centrifugal flow stages.

8. A gas turbine engine comprising:
a compressor;
a turbine including an axial flow direction toward the compressor;
an engine shaft connecting the compressor to the turbine such that the compressor and the turbine rotate together about an axis of the engine;
an annular combustor disposed radially outward from at least a portion of the turbine; the combustor fluidly connected between a the compressor and the turbine; the combustor including an axial flow direction away from the compressor;
a transition duct to fluidly connect the combustor to the turbine; the transition duct transitioning between the axial flow direction of the combustor and the axial flow direction of the turbine;
an exhaust duct fluidly connected to turbine, the exhaust duct disposed between the compressor and the combustor;
a first engine shaft bearing disposed on an axial side of the compressor opposite the turbine, the first engine shaft bearing supporting a first portion of the engine shaft; and
a second engine shaft bearing disposed on an axial side of the turbine opposite the compressor, the second engine shaft bearing supporting a second portion of the engine shaft.

9. The engine of claim 8, further including cross-flow device, the cross-flow device including a compressed air flow path, and an exhaust gas flow path not in fluid contact with the compressed air flow path; wherein the exhaust duct is fluidly connected to the exhaust gas flow path and the compressed air flow path fluidly connects the compressor to the combustor.

10. The engine of claim 9, wherein the cross-flow device is an air-to-air heat exchanger and the compressed air flow path and the exhaust gas flow path are in thermal contact.

11. The engine of claim 8, wherein the turbine is an axial flow turbine.

12. The engine of claim 11, wherein the compressor is centrifugal flow compressor.

13. The engine of claim 11, wherein the compressor is an axial flow compressor

14. The engine of claim 11, wherein the compressor includes both axial and centrifugal flow stages

15. A method of operating a gas turbine engine to keep an engine bearing in a cool region, the engine bearing disposed on an axial side of a turbine opposite a compressor; the method comprising:
flowing air from the compressor to an annular combustor radially outward from the turbine;
combusting the compressed air with fuel to generate a flow of combustion gases in a direction away from the compressor;
directing the flow of combustion gases from the combustor radially inward to the turbine;
expanding the combustion gases through the turbine in a direction at least partially toward the compressor; and
exhausting the expanded combustion gases from the turbine radially outward between the compressor and the combustor.

16. The method of claim 15, wherein the engine bearing is not in the flow of expanded combustion gases exhausting from the turbine.

17. The method of claim 16, wherein the engine bearing is not in the flow of air from the compressor

18. The method of claim 15, wherein:
flowing the compressed air from the compressor to the annular combustor includes flowing the compressed air from the compressor through a heat exchanger between the compressor and the combustor;
exhausting the expanded combustion gases from the turbine includes flowing the exhausted gases through the heat exchanger; and
transferring heat from the exhausted gases to the compressed air in the heat exchanger.
